(19) United States
(12) Patent Application Publication
(10) Pub. No.: US 2026/0296334 A1
(43) Pub. Date: Oct. 1, 2026

(54) VEHICLE PART WITH AESTHETIC CONTRIBUTION

(71) Applicant: OPmobility SE, Lyon (FR)

(72) Inventors: Stéphane GUILLIER, Sainte-Julie (FR); Damien BOISSON, Sainte-Julie (FR); Aurélien MORESSEE, Sainte-Julie (FR); Tina RABAULT, Sainte-Julie (FR); Sascha DUEHR, Sainte-Julie (FR)

(21) Appl. No.: 19/576,259

(22) Filed: Mar. 24, 2026

(30) Foreign Application Priority Data
Mar. 26, 2025 (FR) FR2503124

(51) Int. Cl. B60R 13/04; B60R 19/02

(52) U.S. Cl. CPC B60R 13/04; B60R 19/023

(57) ABSTRACT

A method for manufacturing a vehicle part, the method including successive steps of preparing a decorative film by providing it with a first area including at least one decorative pattern, and a second area including a transparent or translucent window extending through the entire thickness of the decorative film, assembling the decorative film with electronic paper so that the electronic paper extends, at least in part, opposite the transparent or translucent window of the decorative film, and bonding the assembly of the decorative film and the electronic paper to a substrate made of plastic material.

### TECHNICAL FIELD

The invention relates to a motor vehicle part. More particularly, the invention relates to a method for manufacturing a vehicle part which contributes to the appearance of the vehicle, and to a vehicle part obtained by implementing such a method.

### PRIOR ART

A motor vehicle comprises a plurality of parts forming its exterior body and playing a major role in defining the overall aesthetics of the vehicle. It is also possible to treat the external surface of these parts to improve their appearance. A method for manufacturing a vehicle part is known from document FR3099714A1, in which a multilayer paint is applied to a transparent part, then part of the multilayer paint is partially irradiated with laser radiation to create a pattern in the multilayer paint that partially reveals the transparent part. A light source is then placed behind the transparent part, so that the light radiation produced by this light source is visible through the pattern formed in the multilayer paint.

This method makes it possible to improve the aesthetics of the vehicle but can have certain drawbacks. Indeed, the aesthetic effect of the vehicle part described above is produced by a light source and therefore requires a certain amount of energy consumption to maintain this aesthetic effect, which is intended to be avoided. In addition, the method as envisaged in the above-mentioned document involves carrying out all the steps in the presence of the transparent part, so that the entire method must be implemented at a single location, for example in the same factory, and in the presence of all the components of the vehicle part, which does not allow for agile or flexible implementation of this method.

The invention aims in particular to overcome these problems by proposing a method for manufacturing a vehicle part which contributes to the aesthetics of the vehicle which is more agile or flexible to implement than that of the prior art, while reducing the energy impact of this vehicle part.

### SUMMARY OF THE INVENTION

To this end, the invention relates to a method for manufacturing a vehicle part, characterized in that it comprises the following steps:
a) preparing a decorative film by providing it with a first area comprising at least one decorative pattern, and a second area comprising a transparent or translucent window extending through the entire thickness of the decorative film,
b) assembling the decorative film with electronic paper so that the electronic paper extends, at least in part, opposite the transparent or translucent window of the decorative film,
c) bonding the assembly of the decorative film and electronic paper to a molded plastic substrate.

Thus, the aesthetic effect of the vehicle part is achieved in particular by the electronic paper, which does not require a light source as in the vehicle part of the prior art. Since electronic paper enables a text or image to be displayed without consuming any electrical energy, apart from changing the text or image displayed, it is understood that the vehicle part according to the invention has a much lower energy impact than the vehicle part of the prior art.

Further, since the assembly of the decorative film with the electronic paper does not, as such, require the presence of the substrate as a support, it is understood that the various steps of the method according to the invention can be implemented at different locations and at different times. It is thus understood that the invention is particularly agile and flexible to implement, allowing it to adapt to industrial constraints as needed.

Advantageously, the assembly of the decorative film with the electronic paper is formed by lamination, adhesive bonding or gluing.

These methods ensure a particularly robust assembly of the decorative film and the electronic paper, helping to make the vehicle part particularly durable.

According to an embodiment of the invention, step c) consists in overmolding or molding the assembly of the decorative film with the electronic paper onto a substrate which is molded in-situ, for example by injection molding of plastic, preferably polypropylene or polycarbonate.

According to an alternative embodiment of the invention, step c) consists in gluing or adhesively bonding the assembly of the decorative film with the electronic paper to a substrate which is prefabricated, for example by injection molding of plastic, preferably polypropylene or polycarbonate.

The substrate can thus be manufactured using controlled methods, and the same applies to the bonding of the assembly of the decorative film and electronic paper to the substrate.

Advantageously, an electrical connector is connected to the electronic paper prior to implementing step b).

In this way, a connector is installed in the vehicle part, enabling the electronic paper to be connected to a control unit for modifying the display of the electronic paper. In other words, it facilitates future integration of the vehicle part with the vehicle electronics.

Preferably, the electrical connector or the edge of the electronic paper is positioned entirely opposite the first area of the decorative film, without facing the transparent or translucent window.

The edge of the transparent or translucent window makes it possible to conceal the electrical connector or the edge of the electronic paper, which could have a negative impact on the aesthetics of the vehicle part.

Advantageously, prior to implementing step c), the assembly of the decorative film with the electronic paper is preformed so that the electronic paper has a flat or curved shape in a single direction.

This overcomes one of the constraints on the use of electronic paper, since the latter is generally relatively rigid and not very capable of withstanding and maintaining marked or complex shape deformations, and generally functions less well when deformed along several axes.

Advantageously, the method further comprises a step d), after step c), wherein a transparent protective coating is applied onto the decorative film.

This improves the protection of the vehicle part. It can be, for example, a protective coating either ensuring mechanical protection for the vehicle part, for example against scratches, or ensuring optical protection for the vehicle part, for example against ultraviolet radiation from the sun.

Advantageously, the vehicle part is a vehicle body part.

Advantageously, the vehicle body part forms a portion of a tailgate, a bumper, a vehicle door, or any decorative trim part of the vehicle.

The vehicle part thus contributes to the vehicle's aesthetics.

According to the invention, there is also provided a vehicle part comprising:
a decorative film having a first area comprising at least one decorative pattern, and a second area comprising a transparent or translucent window extending through the entire thickness of the decorative film,
electronic paper assembled with the decorative film, the electronic paper extending, at least in part, opposite the transparent or translucent window of the decorative film, and
a substrate made of molded plastic, to which the decorative film and electronic paper are bonded.

Advantageously, the vehicle part further comprises a transparent protective coating applied to the decorative film.

Advantageously, the vehicle part is a vehicle body part, for example a portion of a tailgate, a bumper, a vehicle door or any vehicle decorative trim part of the vehicle.

### BRIEF DESCRIPTION OF THE FIGURES

The invention will be better understood upon reading the following description, which is provided merely by way of example and with reference to the appended drawings, in which:

FIG. 1 is a cross-sectional view of a vehicle part according to one embodiment of the invention,

FIG. 2 is a cross-sectional view of the assembly of a decorative film with electronic paper of the vehicle part of FIG. 1, and

FIG. 3 is a cross-sectional view of a vehicle part according to an alternative embodiment of the invention.

### DETAILED DESCRIPTION

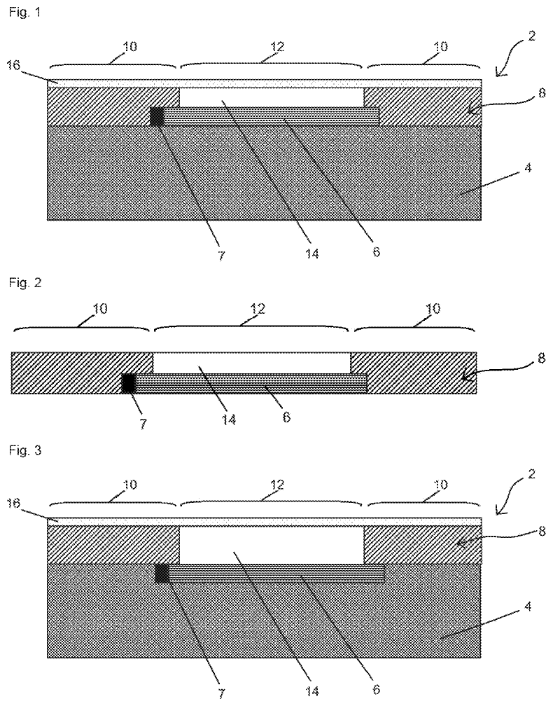

FIG. 1 depicts a vehicle part 2 according to an alternative embodiment of the invention. The part in question here is a vehicle body part, such as a portion of a tailgate or a vehicle door, although other types of vehicle parts may be envisioned.

The vehicle part 2 comprises a substrate 4 made of a plastic material. Here, the substrate is made of polycarbonate (PC) or polypropylene (PP), to name just a few examples, which are plastics that can easily be injection molded.

The vehicle part 2 comprises electronic paper 6 bonded to the substrate 4. The electronic paper 6 is configured to display text and/or images, which can be modified by the application of a momentary electrical voltage. It features the same technology found in e-readers. To this end, the vehicle part 2 comprises an electrical connector 7 connected to the electronic paper 6 and configured to be connected to an electrical control unit (not shown) located outside the vehicle part 2.

The vehicle part 2 comprises a decorative film 8 bonded to the electronic paper 6 and to the substrate 4, with the decorative film 8 completely covering the electronic paper 6.

FIG. 2 shows the electronic paper 6, the electrical connector 7 and the decorative film 8 isolated from the other components of the vehicle part 2. The decorative film 8 comprises a first area 10, which is opaque here, comprising at least one decorative pattern, for example based on paint or other material. The first area 10 comprises, for example, a solid opaque paint, optionally with colored or uncolored shapes, logos or lettering allowing for the presentation of information on the vehicle or contributing to the vehicle's aesthetics. The decorative film 8 comprises a second area 12 comprising a transparent window 14, extending through the entire thickness of the decorative film 8, through which at least a portion of the electronic paper 6 is visible from the outside. The second area 12 of the decorative film 8 therefore does not contain material. According to an alternative embodiment, the window 14 is translucent instead of being transparent. The shape of the transparent window 14 is chosen here to be inscribed in the shape of the electronic paper 6, so that edges of the electronic paper 6 are at least partly concealed by the edges of the transparent window 14. In particular, the connector 7 is here concealed by the edges of the transparent window 14. In this embodiment, the electronic paper 6 is housed within the thickness of the decorative film 8.

The vehicle part 2 further comprises a protective coating 18 applied to the decorative film 8. The protective coating 16 is transparent. It can be, for example, a protective coating, such as a varnish, either ensuring mechanical protection for the vehicle part, for example against scratches, or ensuring optical protection for the vehicle part, for example against ultraviolet radiation from the sun.

Parallel to a stacking axis, vertical in FIG. 1, the vehicle part 2 comprises the following successive layers in the first area 10: substrate 4, partly the edge of the electronic paper 6, decorative film 8, protective coating 16. And, parallel to the stacking axis, the vehicle part 2 comprises the following successive layers in the second area 12: substrate 4, electronic paper 6, transparent window 14 of decorative film 8, protective coating 16.

A description will now be given of a method for manufacturing the vehicle part 2 according to one embodiment of the invention.

According to this manufacturing method, a step a) is first implemented, during which the decorative film 8 is prepared by providing it with the first area 10 comprising the at least one decorative pattern, and a second area 12 comprising the transparent window 14 extending through the entire thickness of the decorative film 8. This transparent window 14 is formed in the decorative film 8 by laser engraving, cutting or masking. The electronic paper 6 is then placed on the decorative film 8, facing the transparent window 14, and the electrical connector 7 is connected to the electronic paper 6.

A step b) is then implemented, in which the decorative film 8 is assembled with the electronic paper 6 so that the electronic paper 6 extends, at least in part, opposite the transparent window 14 of the decorative film 8. This assembly is formed by lamination, adhesive bonding or gluing, so that the electronic paper 6 and the electrical connector 7 are bonded to the decorative film 8. An assembly is thus obtained, as shown in FIG. 2. In addition, the assembly of the decorative film 8 with the electronic paper 6 is preformed so that the electronic paper 6 has a flat shape or a curved shape in one direction only. This ensures that the electronic paper 6, and consequently the vehicle part 2, function optimally upon completion of the manufacturing method.

A step c) is then implemented, in which the assembly of the decorative film 8 and the electronic paper 6 is bonded to the substrate 4. According to one embodiment of the invention, step c) consists in overmolding or insert-molding the assembly of the decorative film 8 with the electronic paper 6 in an injection mold into which the material constituting the substrate 4, such as polycarbonate or polypropylene, is injected. According to an alternative embodiment, step c) consists in gluing the assembly of the decorative film 8 with the electronic paper 6 onto a substrate 4, which is prefabricated or manufactured in step c) independently of the gluing of the assembly onto the substrate 4. In this step c), the shape of the substrate 4 is chosen so that it forms a body part, in this case a portion of a tailgate or a vehicle door as mentioned above.

Finally, step d) is implemented, in which the transparent protective coating 16 is applied to the decorative film 8 in order to obtain the vehicle part.

FIG. 3 depicts a vehicle part 2 according to an alternative embodiment of the invention. This vehicle part 2 differs from that of the previous embodiment in that the electronic paper 6 is housed in a shoulder of the substrate 4, instead of a shoulder of the decorative film 8. The constituent elements of this vehicle part 2, as well as its manufacturing method, are similar to those of the vehicle part of the previous embodiment disclosed above.

The invention is not limited to the embodiments presented, and other embodiments will become clearly apparent to a person skilled in the art.

### LIST OF REFERENCES

2: vehicle part
4: substrate
6: electronic paper
7: electrical connector
8: decorative film
10: first area
12: second area
14: transparent or translucent window
16: protective coating

1. A method for manufacturing a vehicle part, comprising steps of:
a) preparing a decorative film by providing it with a first area comprising at least one decorative pattern, and a second area comprising a transparent or translucent window extending through an entire thickness of the decorative film,
b) assembling the decorative film with electronic paper so that the electronic paper extends, at least in part, opposite the transparent or translucent window of the decorative film, and
c) bonding the assembly of the decorative film and electronic paper to a molded plastic substrate.

2. The method according to claim 1, wherein the assembly of the decorative film with the electronic paper is formed by lamination, adhesive bonding or gluing.

3. The method according to claim 1, wherein step c) consists in overmolding or molding the assembly of the decorative film with the electronic paper onto a substrate which is molded.

4. The method according to claim 3, wherein the substrate is molded by injection molding of plastic.

5. The method according to claim 4, wherein the plastic of the substrate is polypropylene or polycarbonate.

6. The method according to claim 1, wherein step c) consists in gluing or adhesively bonding the assembly of the decorative film with the electronic paper to a substrate which is prefabricated.

7. The method according to claim 6, wherein the substrate is prefabricated by injection molding of plastic.

8. The method according to claim 7, wherein the plastic of the substrate is polypropylene or polycarbonate.

9. The method according to claim 1, wherein an electrical connector is connected to the electronic paper before implementing step b).

10. The method according to claim 9, wherein the electrical connector or an edge of the electronic paper is placed entirely opposite the first area of the decorative film without facing the transparent or translucent window.

11. The method according to claim 1, wherein prior to implementing step c), the assembly of the decorative film with the electronic paper is preformed so that the electronic paper has a flat or curved shape in a single direction.

12. The method according to claim 1, further comprising a step d) in which, after step c), a transparent or translucent protective coating is applied to the decorative film.

13. The method according to claim 1, wherein the vehicle part is a vehicle body part.

14. The method according to claim 13, wherein the vehicle body part forms a portion of a tailgate, a bumper, a vehicle door, or any decorative trim part of the vehicle.

15. A vehicle part, comprising:
a decorative film having a first area comprising at least one decorative pattern, and a second area comprising a transparent or translucent window extending through an entire thickness of the decorative film,
electronic paper assembled with the decorative film, the electronic paper extending, at least in part, opposite the transparent or translucent window of the decorative film, and
a substrate made of molded plastic, to which the assembly of the decorative film and the electronic paper is bonded.

16. The vehicle part according to claim 15, further comprising a transparent or translucent protective coating applied to the decorative film.

17. The vehicle part according to claim 15, the vehicle part being a vehicle body part.

18. The vehicle part according to claim 17, wherein the vehicle body part is a portion of a tailgate, a bumper, a vehicle door, or any decorative trim part of the vehicle.
